(19) United States
(12) Patent Application Publication
(10) Pub. No.: US 2014/0281164 A1
(43) Pub. Date: Sep. 18, 2014

(54) MEMORY SYSTEM AND MEMORY CONTROLLER

(71) Applicant: KABUSHIKI KAISHA TOSHIBA, Minato-ku (JP)

(72) Inventor: Takahide NISHIYAMA, Yokohama-shi (JP)

(73) Assignee: KABUSHIKI KAISHA TOSHIBA, Minato-ku (JP)

(21) Appl. No.: 14/020,305

(22) Filed: Sep. 6, 2013

Related U.S. Application Data
(60) Provisional application No. 61/783,530, filed on Mar. 14, 2013.

(51) Int. Cl. G06F 12/02

(52) U.S. Cl. CPC G06F 12/0246
USPC 711/103

(57) ABSTRACT

According to one embodiment, a memory system includes a plurality of nonvolatile semiconductor memories including a plurality of memory cell transistors for holding data, and holding position information indicating a position of a defective memory cell transistor incapable of normally holding data and a position of a substitute portion for the defective memory cell transistor.

### CROSS-REFERENCE TO RELATED APPLICATIONS

This application claims the benefit of U.S. Provisional Application No. 61/783,530, filed Mar. 14, 2013, the entire contents of which are incorporated herein by reference.

### FIELD

Embodiments described herein relate generally to a high-quality memory system and controller.

### BACKGROUND

Recently, a flash memory device as a nonvolatile semiconductor memory system is widely used as an external memory of a host device such as a digital camera and a boot memory system of a computer system, because the flash memory device is electrically programmable and capable of holding data even when the power supply is shut down.

### BRIEF DESCRIPTION OF THE DRAWINGS

FIG. 1 is a view schematically showing the basic configuration of a memory system according to an embodiment;

FIG. 2 is an exemplary circuit diagram showing a memory according to the embodiment;

FIG. 3 is an exemplary view showing the arrangement of a memory space according to the embodiment;

FIG. 4 is an exemplary view showing the arrangement of one page according to the embodiment;

FIG. 5 is an exemplary view showing the arrangement of a RAM according to the embodiment;

FIG. 6 is an exemplary view showing the arrangement of a NAND flash interface according to the embodiment;

FIG. 7 is an exemplary view showing mapping of a memory space of a CBP register according to the embodiment;

FIG. 8 is an exemplary view showing a part of a bank register according to the embodiment;

FIG. 9 is an exemplary view showing the arrangement of an instruction code according to the embodiment;

FIG. 10 is a flowchart showing the basic operation of the NAND flash interface according to the embodiment; and

FIG. 11 is a timing chart showing the operation timings of the memory system according to the embodiment.

### DETAILED DESCRIPTION

In general, according to one embodiment, a memory system includes

a plurality of nonvolatile semiconductor memories including a plurality of memory cell transistors for holding data, and holding defect position information indicating a position of a defective memory cell transistor incapable of normally holding data and a position of a substitute portion for the defective memory cell transistor,

a first controller which selects a nonvolatile semiconductor memory to be accessed,

a first memory which stores the defect position information held in the nonvolatile semiconductor memories and corresponding to each nonvolatile semiconductor memory,

a second memory which holds a plurality of codes each containing at least an instruction portion, and first information indicating the nonvolatile semiconductor memory to be accessed by the instruction portion, and outputs the code corresponding to the nonvolatile semiconductor memory selected by the first controller,

a decoder which decodes the code supplied from the second memory, and reads out the instruction portion and the first information,

a third memory which stores the defect position information of one of the nonvolatile semiconductor memories,

a fourth memory which stores second information indicating the nonvolatile semiconductor memory corresponding to the defect position information stored in the third memory, and

a second controller which controls the first memory and the third memory,

wherein the decoder reads out the second information from the fourth memory, and compares the first information with the second information, and

notifies the second controller of a result of the comparison, and

the second controller reads out, when receiving a notification indicating that the first information differs from the second information, defect position information corresponding to the nonvolatile semiconductor memory to be accessed by the instruction portion, from the first memory based on the first information,

updates the defect position information stored in the third memory to the readout defect position information, and

executes an operation based on the instruction portion by using the defect position information stored in the third memory, after the defect position information stored in the third memory is updated or when receiving a notification indicating that the first information and the second information are the same.

Details of the embodiment will be explained below with reference the accompanying drawings. Note that in the following explanation, the same reference numerals denote components having almost the same functions and arrangements, and a repetitive explanation will be made only when necessary. Note also that each embodiment to be explained below exemplarily discloses an apparatus and/or method for embodying the technical idea of the present embodiments, and the technical idea of the embodiment does not specify the materials, shapes, structures, layouts, and the like of components to those described below. The technical idea of the embodiment can variously be changed within the scope of the appended claims.

### Embodiment

### Outline of Memory System According to Embodiment

As shown in FIG. 1, a memory system 100 includes a memory controller (to be also simply referred to as a controller) 100a, and a plurality of NAND flash memory chips (to be also referred to as nonvolatile semiconductor memories, NAND flashes, NAND memories, NAND chips, flash memories, memory chips, or chips) 110.

Note that this embodiment includes n+1 (n is an integer of 1 or more) NAND flash memory chips (chips 0 to n) as an example. When it is unnecessary to distinguish between the NAND flash memory chips, they will simply be referred to as chips or the NAND flash memory chips 110. When it is necessary to distinguish between the NAND flash memory chips 110, they will be referred to as chips 0 to n.

Also, this embodiment will be explained by using the NAND flash memory chips, but the present embodiment is not necessarily limited to this.

The memory controller 100a includes a host interface (to be also simply referred to as a host IF) 101, a memory buffer 102, a CPU (Central Processing Unit) 103, a BUS 104, a ROM 105, a RAM 106, a NAND flash interface (to be also simply referred to as a flash IF) 107, and a DMA controller 108.

The host interface 101 is connected to a host device (external device) 200 such as a personal computer, and further connected to a BUS 300. That is, the host device 200 and memory system 100 exchange commands, addresses, data, control signal data, and the like via the host interface 101.

The memory buffer 102 is connected to the host interface 101, and further connected to the BUS 104. The memory buffer 102 receives, via the host interface 101, data transmitted from the host device 200 to the memory system 100, and temporarily holds the data. Also, the memory buffer 102 temporarily holds data to be transmitted from the memory system 100 to the host device 200 via the host interface 101.

The CPU 103 controls the operation of the whole memory system 100. The CPU 103 reads out information stored in the ROM 105 and RAM 106 via the BUS 104, and executes predetermined processing based on the information and access from the host device 200.

The ROM 105 is a nonvolatile memory, and stores, e.g., control programs to be controlled by the CPU 103. The RAM 106 is a volatile memory to be used as a work area of the CPU 103, and temporarily stores, e.g., variables necessary for the work of the CPU 103. The RAM 106 also holds inherent column defect position information of each chip (to be described later).

The NAND flash interface 107 is connected to the NAND flash memory chips 110 via a BUS 400. Also, the NAND flash interface 107 exchanges data and the like with the host device 200 and memory system 100 via the BUS 104.

The DMA controller 108 is a circuit for controlling direct memory access (to be referred to as DMA hereinafter) by which an apparatus such as a host device and a memory device directly exchange data without intervening the CPU 103. The DMA controller 108 starts DMA when the CPU 103 sets a predetermined value in an internal control register of the NAND flash interface 107 (to be described later).

The plurality of NAND flash memory chips 110 are connected to the NAND flash interface 107 via the BUS 400, and each NAND flash memory chip 110 includes a memory cell array 111. The memory cell array 111 includes a plurality of bit lines, a plurality of word lines, and a common source line. In the memory cell array 111, electrically programmable memory cells such as EEPROM cells are arranged in a matrix. The memory cell array 111 holds the address of an inherent column defect that exists when the memory system 100 is shipped, and is detected based on an experiment or the like conducted at the time of, e.g., the shipment.

### <Overall Arrangement of Memory Cell Array>

Next, an outline of the arrangement of the memory cell array 111 according to the embodiment will be explained with reference to FIG. 2. FIG. 2 is a circuit diagram schematically showing the basic arrangement of the memory cell array 111 according to the embodiment.

As shown in FIG. 2, the memory cell array 111 includes a plurality of bit lines BL, a plurality of word lines WL, and a source line SL. The memory cell array 111 includes a plurality of blocks BLK in each of which electrically programmable memory cell transistors (to be also simply referred to as, e.g., memory cells) MT are arranged in a matrix. The memory cell transistor MT has a stacked gate including a control gate electrode CG and a charge storage layer (e.g., a floating gate electrode) CS, and stores multilevel data in accordance with the change in threshold of the transistor, which is determined by a charge amount injected into the floating gate electrode. The memory cell transistor MT may also have a MONOS (Metal-Oxide-Nitride-Oxide-Silicon) structure in which electrons are trapped in a nitride film.

For example, the memory cell array 111 performs data write and read page by page. As shown in FIG. 2, each page is a memory space of a set of a plurality of memory cell transistors, and a unique physical address is allocated to the page. Each memory cell transistor MT changes the threshold voltage in accordance with the number of electrons stored in the charge storage layer CS, and stores information corresponding to the threshold voltage. A NAND string is formed by connecting the current paths (sources/drains SD) of the memory cell transistors MT in series, and selection transistors S1 and S2 are connected to the two ends of the NAND string. The other end of the current path of the selection transistor S2 is connected to the bit line BL, and the other end of the current path of the selection transistor S1 is connected to the source line

SL.

Word lines WL0 to WL63 extend in the WL direction, and are connected to the control gate electrodes CG of a plurality of memory cell transistors MT belonging to the same row. The memory cell transistors MT are formed at the intersections of the bit lines BL and word lines WL. A select gate line SGD extends in the WL direction, and is connected to all selection transistors S2 in the block. A select gate line SGS extends in the WL direction, and is connected to all selection transistors S1 in the block. A plurality of memory cell transistors MT connected to the same word line WL form a page.

As shown in FIG. 3, the memory cell array 111 includes a memory cell array 91 including a plurality of memory cell transistors, and a page buffer 92 for exchanging data with the memory cell transistors. The page buffer 92 holds data of one page. When writing data in the memory cell array 111, the memory controller 100a transmits a write command, a page address indicating the write destination, and write data of one page to the memory cell array 111. The memory cell array 111 stores the write data received from the memory controller 100a in the page buffer 92, and writes the write data in memory cells designated by the page address from the page buffer 92. When starting this write operation to the memory cells, the memory cell array 111 outputs a busy signal indicating that the operation is in progress, to the memory controller 100a. When successively writing data, the same operation as above is performed for the next page address after the busy signal is switched to a ready signal.

When reading out data from the memory cell array 111, the memory controller 100a transmits a read command and a page address indicating the read source to the memory cell array 111. The memory cell array 111 reads out data of one page to the page buffer 92 from memory cells designated by the page address. When staring this read operation from the memory cells, the memory cell array 111 outputs a busy signal to the memory controller 100a. After the busy signal is switched to a ready signal, the readout data stored in the page buffer 92 is output to the memory controller 100a. When successively reading out data, the same operation as above is performed for the next page address.

The memory cell transistor MT can take two or more states having different threshold voltages. That is, the memory cell array 111 can also be configured so that one memory cell can store multilevel data (multi-bit data). In a memory thus capable of storing multilevel data, a plurality of pages are allocated to one word line.

Also, the memory cell array 111 erases data block by block. Each block includes a plurality of pages having consecutive physical addresses. However, the memory cell array 111 is not necessarily limited to a NAND flash memory.

### <Arrangement of Page>

Next, a practical example of one page according to this embodiment will be explained with reference to FIG. 4.

As shown in FIG. 4, one page holds 8-KB data in this embodiment. However, an inherent column defect unusable as a data storage area sometimes exists due to, e.g., the manufacturing process of the memory cell array 111. By assuming a case like this, one page includes a normal use area 93 capable of holding 8-KB data, and a redundant area 94 capable of holding 1-KB data. Therefore, if an inherent column defective portion 95 in which an inherent column defect has occurred is found in the normal use area 93 by, e.g., a test conducted before the memory system 100 is shipped, a portion of the redundant area 94, which can normally hold data is used as a substitute portion 96 instead. Thus, one page can hold 8-KB data even if a column defect occurs.

The position of the inherent column defective portion 95 and the position of the substitute portion 96 to be used instead of the inherent column defective portion 95 are registered as inherent column defect position information. The memory cell array 111 holds the inherent column defect position information of each chip.

As shown in FIG. 5, when the memory system 100 is powered on, the CPU 103 reads out the inherent column defect position information of each chip from the memory cell array 111, and stores the readout information in the RAM 106.

### <Arrangement of NAND Flash Interface>

The NAND flash interface 107 according to this embodiment will be explained below with reference to FIG. 6.

As shown in FIG. 6, the NAND flash interface 107 includes a control register 501, NAND bus controller 502, decoder 503, NAND sequence memory 504, CBP (Current Bank Pointer) register 505, bank interface (bank IF) 506, bank register 507, and program counter 508.

Information necessary for the operation of the NAND flash interface 107 is set in the control register 501.

The NAND bus controller 502 accesses the NAND flash memory 110 or controls the state of the BUS 400 based on an instruction from, e.g., the CPU 103 or decoder 503.

A sequence code obtained by coding a sequence for accessing the NAND flash memory 110 is stored in the NAND sequence memory 504. The sequence code contains a plurality of instruction codes.

For example, when a write command request is issued from the host device 200, a series of four commands, i.e., (i) an erase command, (ii) a status read command, (iii) a write command, and (iv) a status read command are sometimes issued to the NAND flash memory 110 as a write operation target. The sequence code is obtained by coding these four commands as one sequence by assuming a case like this. By only setting this sequence code in the NAND interface 502, it is possible to successively execute the series of commands on the NAND flash memory 110.

A start address containing the sequence code in the NAND sequence memory 504 is set in the program counter (PC) 508.

The decoder 503 decodes the sequence code read out from the NAND sequence memory 504 so that the NAND bus controller 502 can execute the code, and outputs the decoded signal. Also, the decoder 503 compares an NBP (Next Bank Pointer) (to be explained later) contained in an instruction code as a part of the sequence code with a CBP (Current Bank Pointer) held in the CBP register 505, and outputs the comparison result to the bank interface 506.

The CBP register 505 holds a current bank pointer (CBP) indicating a bank corresponding to column defect position information stored in a current bank register.

The bank interface 506 controls bank switching based on a transfer instruction from the NAND flash bus controller 502, or the CBP register 505.

The bank register 507 is, e.g., a flip-flop, and stores column defect position information of an inherent column defect of one chip.

Next, mapping of the memory space of the CBP register 505 will be explained with reference to FIG. 7.

As shown in FIG. 7, the CBP register 505 has a 32-bit memory space, and a CBP as a pointer indicating a chip corresponding to column defect position information currently held in the bank register 507 is stored in a [4:0]-bit space. In addition, a bank switch (BSW) indicating whether the CBP is valid or invalid is stored in a [31]-bit space.

A part of the memory space in the bank register 507 will be explained below with reference to FIG. 8.

As shown in FIG. 8, one column defect position information is stored in a [14:0]-bit space, and a valid flag indicating whether this column defect position information is valid is stored in a [15]-bit space. The bank register 507 includes, e.g., about 48 such memory spaces. Consequently, one chip can cope with up to 48 bytes of column defects.

### <Arrangement of Instruction Code>

The instruction code will now be explained with reference to FIG. 9.

The instruction code is an instruction required to access the NAND flash memory 110, and obtained by programming the operation of accessing the NAND flash memory 110. This instruction contains, e.g., an instruction for accessing data page by page from the NAND flash memory 110.

As shown in FIG. 9, the instruction code (16 bits) as a part of the sequence code includes an instruction portion (8 bits) and NBP (Next Bank Pointer) (4 bits). In the instruction portion, for example, a DIFMT instruction for reading data from the NAND flash memory 110 or a DOFMT instruction for programming data in the NAND flash memory 110 is set. The NBP is a bank pointer indicating, e.g., a chip as an access target of the instruction. This instruction code is prepared for, e.g., each NBP (e.g., each of chips 0 to n). When the CPU 103 sets a program counter value for requesting access to, e.g., chip 0 in the control register 501, a sequence code containing an instruction code having an NBP corresponding to chip 0 is selected from the NAND sequence memory 504.

When executing an instruction such as a write command request from the host device 200, column defect position information of an inherent column defect in a chip as a target of the write operation is necessary to correctly write data in the chip. That is, when the abovementioned instruction is a write operation, it is necessary to avoid data transfer to a column defective portion, so the NAND flash interface 107 transfers dummy data to the column defective portion. Then, the NAND flash interface 107 transfers correct data to a substitute portion formed in a redundant area. In the operation of the DOFMT instruction by which 8-KB data is transferred to one page, 10 bytes of inherent column defects sometimes exist in one page as a target. In this case, the NAND flash interface 107 transfers 8-KB+10-byte data to the target page.

Similarly, when the abovementioned instruction is a read operation, data read out from a column defective portion is destroyed data. Therefore, the NAND bus controller 502 discards the data, and performs control so as to read out data from a substitute portion corresponding to the column defective portion (this operation is also called column skip).

### <Operation of NAND Flash Interface>

Next, the basic operation of the NAND flash interface according to this embodiment will be explained with reference to FIGS. 10 and 11. FIG. 10 is a flowchart showing the basic operation of the NAND flash interface according to this embodiment. FIG. 11 is a timing chart showing the operation timings of the memory system 100 according to this embodiment.

### [Step S1000]

The memory system 100 receives a command (also called a host command) from the host device 200. The CPU 103 interprets the received host command.

### [Step S1001]

The control register 501 receives an activation bit, program counter value, and the like from the CPU 103 via the BUS 104. Then, the control register 501 sets the program counter value in the PC 508. Based on the received activation bit, the control register 501 activates the NAND flash interface 107 and DMA controller 108, and starts accessing the NAND flash memory 110. In other words, the DMA controller 108 starts DMA.

### [Step S1002]

Based on the program counter value set in the PC 508, the NAND sequence memory 504 supplies a sequence code having a corresponding NBP to the decoder 503.

The decoder 503 fetches the sequence code from the NAND sequence memory 504, and decodes the sequence code.

### [Step S1003]

The decoded sequence code contains the instruction portion (e.g., DOFMT or DOFMT), and the bank pointer (NBP) as information of a chip to be accessed. Therefore, the decoder 503 reads out the CBP and BSW from the CBP register 505.

Then, the decoder 503 determines whether the BSW bit is set (enabled) and the CBP and NBP do not match.

### [Step S1004]

If the decoder 503 determines in step S1003 that the BSW bit is set (enabled) and the CBP and NBP do not match, the bank interface 506 starts switching column defect position information in the bank register 507 (this operation is also called bank switching) in accordance with the NBP from the decoded information.

More specifically, the decoder 503 notifies the bank interface 506 that the BSW bit is set (enabled) and the CBP and NBP do not match. The bank interface 506 supplies a chip switching request signal (INTREQ) and a chip selection request based on the NBP to the DMA controller 108. At this timing, the bank interface 506 once clears all valid bits (V) indicating the validness of the bank register 507. Then, column defect position information stored in the RAM 106 and indicating the chip to be accessed is selected based on the chip selection request.

When the bank interface 506 starts updating the column defect position information in the bank register 507, the NAND bus controller 502 changes the state of the BUS 400 from an IDLE state to a BANK state. Also, when the bank switching operation is once started, the NAND bus controller 502 temporarily stops transfer control to the NAND flash memory 110 during this period.

### [Step S1005]

The bank interface 506 receives transfer data (DATA) from the RAM 106, and receives a valid signal (ACK) transmitted from the DMA controller 108 in synchronism with the transfer data.

The bank interface 506 sets a valid bit (V) whenever writing the transferred column defect position information in the bank register 507.

### [Step S1006]

The bank interface 506 receives a completion notification signal (LAST) from the DMA controller 108 in a cycle for receiving last data.

### [Step S1007]

If the decoder 503 determines in step S1003 that the BSW bit is set (enabled) and the CBP and NBP match, no bank switching is performed, and the present bank register information is directly used.

When the bank interface 506 has received the completion notification signal in step S1006, the bank interface 506 changes the BUS 400 from the BANK state to a RDY (ready) state via the NAND bus controller 502, thereby terminating the bank switching operation.

Then, the NAND bus controller 502 cancels the temporarily stopped state of transfer control to the NAND flash memory 110, and starts transferring data between the NAND flash memory 110 and memory controller 100a. After that, transfer control to the NAND flash memory 110 is performed based on appropriate column defect position information such that data is transferred while the column skip operation is performed.

In addition, the decoder 503 updates the CBP in the CBP register to the NBP.

### [Step S1008]

If the CPU 103 supplies a new program counter value to the control register 501, the operation in step S1002 is performed for the new program counter value after the present instruction is completed.

### Functions and Effects of this Embodiment

According to this embodiment, in synchronism with the execution of an instruction for a chip access operation, the NAND flash interface 107 determines whether column defect position information of a chip as an access target is stored in the bank register 507. If the NAND flash interface 107 determines that the column defect position information of the chip as an access target is not stored in the bank register 507, the bank interface 506 automatically transfers the column defect position information of the chip as an access target from the RAM 106 to the bank register 507.

The memory system 100 including the plurality of NAND flash memories 110 must hold pieces of column defect position information equal in number to the NAND flash memories 110. When the memory system 100 is activated, however, pieces of column defect position information are stored in the RAM 106, and column defect position information of one chip is held in the bank register 507, in order to prevent an increase in circuit area. Therefore, the column defect position information in the bank register 507 must be updated whenever chips to be accessed are switched.

As shown in FIG. 11, the bank switching operation is completed by, e.g., about 13 cycles.

By contrast, when performing the bank switching operation by firmware (FW) processing without using the above-described CBP and NBP, not only the information updating time in the bank register 507, but also processing times such as the interrupt response time of the CPU 103 and the activation reset time of the memory controller are added. This extremely deteriorates the system performance.

When accessing a plurality of NAND flash memories 110 by using the memory controller 100a according to this embodiment, however, it is possible to update column defect position information of the NAND flash memory 110 to be accessed without performing the FW processing by the memory controller 100a. Consequently, the memory controller 100a according to this embodiment can improve the performance of access to the NAND flash memory 110, and hence can improve the performance of the memory system 100.

Also, the bank register 507 need not hold column defect position information of a plurality of chips, and therefore need only have a minimum necessary register configuration. Accordingly, the memory system 100 can rapidly be operated without increasing the circuit scale.

Note that the memory system 100 includes a plurality of NAND flash memories 110 in the above-described embodiment, but the present embodiment is not necessarily limited to this. For example, the above embodiment is also applicable even when the memory system 100 includes one NAND flash memory 110. More specifically, the above embodiment is applicable when, e.g., a plurality of pieces of column defect position information are set based on, e.g., addresses in the NAND flash memory 110.

In the above-described embodiment, column defect position information of each chip is held in the bank register 507. However, the present embodiment is not limited to this. For example, it is also possible to divide m chips of the memory system 100 into k (k=m/n) groups each including n chips, and hold column defect position information of each group in the bank register 507.

Furthermore, an inherent column defect has been explained in the above-described embodiment, but the present embodiment is not necessarily limited to this. That is, a similar embodiment is applicable even for a posteriori column defect that occurs as the memory system 100 is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a plurality of nonvolatile semiconductor memories including a plurality of memory cell transistors for holding data, and holding defect position information indicating a position of a defective memory cell transistor incapable of normally holding data and a position of a substitute portion for the defective memory cell transistor;
a first controller which selects a nonvolatile semiconductor memory to be accessed;
a first memory which stores the defect position information held in the nonvolatile semiconductor memories and corresponding to each nonvolatile semiconductor memory;
a second memory which holds a plurality of codes containing at least an instruction portion, and first information indicating the nonvolatile semiconductor memory to be accessed by the instruction portion, and outputs the code corresponding to the nonvolatile semiconductor memory selected by the first controller;
a decoder which decodes the code supplied from the second memory, and reads out the instruction portion and the first information;
a third memory which stores the defect position information of one of the nonvolatile semiconductor memories;
a fourth memory which stores second information indicating the nonvolatile semiconductor memory corresponding to the defect position information stored in the third memory; and
a second controller which controls the first memory and the third memory,
wherein the decoder reads out the second information from the fourth memory, and compares the first information with the second information, and
notifies the second controller of a result of the comparison, and
the second controller reads out, when receiving a notification indicating that the first information differs from the second information, defect position information corresponding to the nonvolatile semiconductor memory to be accessed by the instruction portion, from the first memory based on the first information,
updates the defect position information stored in the third memory to the readout defect position information, and
executes an operation based on the instruction portion by using the defect position information stored in the third memory, after the defect position information stored in the third memory is updated or when receiving a notification indicating that the first information and the second information are the same.

2. The system according to claim 1, further comprising a third controller which controls connection to the nonvolatile semiconductor memory by the second controller.

3. The system according to claim 2, wherein the third controller stops transmission/reception of data to/from the nonvolatile semiconductor memory while the defect position information stored in the third memory is updating.

4. The system according to claim 1, wherein
when writing data in the nonvolatile semiconductor memory, the second controller supplies dummy data to the defective memory cell transistor, and supplies, to the substitute portion, data to be supplied to the defective memory cell transistor, by using the defect position information stored in the third memory, and
when reading out data from the nonvolatile semiconductor memory, the second controller discards data read out from the defective memory cell transistor, and reads out data from the substitute portion, by using the defect position information stored in the third memory.

5. The system according to claim 1, wherein after the defect position information in the third memory is updated, the decoder updates the second information in the fourth memory to the first information.

6. The system according to claim 1, wherein the third memory comprises a flip-flop.

7. The system according to claim 1, wherein the first memory is a volatile semiconductor memory.

8. The system according to claim 1, wherein
the nonvolatile semiconductor memory comprises a plurality of pages each including a plurality of memory cell transistors, and
a substitute portion for the defective memory cell transistor of a predetermined page is formed in the predetermined page.

9. A memory controller for accessing a plurality of nonvolatile semiconductor memories including a plurality of memory cell transistors for holding data, and holding defect position information indicating a position of a defective memory cell transistor incapable of normally holding data and a position of a substitute portion for the defective memory cell transistor,
the memory controller comprising:
a first controller which selects a nonvolatile semiconductor memory to be accessed;
a first memory which stores the defect position information held in the nonvolatile semiconductor memories and corresponding to each nonvolatile semiconductor memory;
a second memory which holds a plurality of codes each containing at least an instruction portion, and first information indicating the nonvolatile semiconductor memory to be accessed by the instruction portion, and outputs the code corresponding to the nonvolatile semiconductor memory selected by the first controller;
a decoder which decodes the code supplied from the second memory, and read out the instruction portion and the first information;
a third memory which stores the defect position information of one of the nonvolatile semiconductor memories;
a fourth memory which stores second information indicating the nonvolatile semiconductor memory corresponding to the defect position information stored in the third memory; and
a second controller which controls the first memory and the third memory,
wherein the decoder reads out the second information from the fourth memory, and compares the first information with the second information, and
notifies the second controller of a result of the comparison, and
the second controller reads out, when receiving a notification indicating that the first information differs from the second information, defect position information corresponding to the nonvolatile semiconductor memory to be accessed by the instruction portion, from the first memory based on the first information,
updates the defect position information stored in the third memory to the readout defect position information, and
executes an operation based on the instruction portion by using the defect position information stored in the third memory, after the defect position information stored in the third memory is updated or when receiving a notification indicating that the first information and the second information are the same.

10. The controller according to claim 9, further comprising a third controller which controls connection to the nonvolatile semiconductor memory by the second controller.

11. The controller according to claim 10, wherein the third controller stops transmission/reception of data to/from the nonvolatile semiconductor memory while the defect position information stored in the third memory is updating.

12. The controller according to claim 9, wherein
when writing data in the nonvolatile semiconductor memory, the second controller supplies dummy data to the defective memory cell transistor, and supplies, to the substitute portion, data to be supplied to the defective memory cell transistor, by using the defect position information stored in the third memory, and
when reading out data from the nonvolatile semiconductor memory, the second controller discards data read out from the defective memory cell transistor, and reads out data from the substitute portion, by using the defect position information stored in the third memory.

13. The controller according to claim 9, wherein after the defect position information in the third memory is updated, the decoder updates the second information in the fourth memory to the first information.

14. The controller according to claim 9, wherein the third memory comprises a flip-flop.

15. The controller according to claim 9, wherein the first memory is a volatile semiconductor memory.

16. The controller according to claim 9, wherein
the nonvolatile semiconductor memory comprises a plurality of pages each including a plurality of memory cell transistors, and
a substitute portion for the defective memory cell transistor of a predetermined page is formed in the predetermined page.
